(19) United States
(12) Patent Application Publication
(10) Pub. No.: US 2012/0176448 A1
(43) Pub. Date: Jul. 12, 2012

(54) HIGH-SPEED PAGE WIDE PRINTING METHOD AND A PRINTING DEVICE ADAPTIVE TO THE HIGH-SPEED PAGE WIDE PRINTING METHOD

(76) Inventors: Hao Jan MOU, Hsin-Chu (TW); Ta Wei HSUEH, Hsin-Chu (TW); Kwo Yuan SHI, Hsin-Chu (TW); Ying Lun CHANG, Hsin-Chu (TW); Ching Sung LIN, Hsin-Chu (TW); Shen Yuan FAN, Hsin-Chu (TW)

(21) Appl. No.: 13/346,141

(22) Filed: Jan. 9, 2012

(30) Foreign Application Priority Data
Jan. 10, 2011 (CN) 201110026485.8

(51) Int. Cl. B41J 2/155

(52) U.S. Cl. 347/42

(57) ABSTRACT

The present invention related to a high-speed page wide printing method, comprising the steps of: providing a printing device and a medium, wherein the printing device at least comprises an ink-jet device including a plurality of odd-number ink-jet nozzles and a plurality of even-number ink-jet nozzles; the printing device receiving a printing order and the ink-jet device executing an ink-jet operation in response to the printing order; and the ink-jet device completing the ink-jet operation for completing a printing operation to a first printing region of the medium. Besides, the odd-number ink-jet nozzle and the adjacent even-number ink-jet nozzle of the ink-jet device form a set and are controlled by the same set of printing control data. Moreover, the ink injected through the plurality of odd-number ink jet nozzle is at least partially overlapped with the ink injected through the adjacent even-number ink-jet nozzle on the medium.

### CROSS REFERENCE TO RELATED APPLICATION

This application claims the benefits of the China Patent Application Serial Number 201110026485.8, filed on Jan. 10, 2011, the subject matter of which is incorporated herein by reference.

### BACKGROUND OF THE INVENTION

1. Field of the Invention

The present invention relates to a printing method and, more particularly, to a high-speed page wide printing method, and a printing device adaptive to the high-speed page wide printing method.

2. Description of Related Art

In recent years, with the improvement of the technology and the promotion of the environment protection sense of the industry, the technology, the device and the equipment that can decrease the cost and minimize the unnecessary waste have become the key-points of the research, both to the industry and the academic world. With the research and development of the technology, the device and the equipment, the operating cost of the industry can be decreased, and put more value into the brand of the industry. Moreover, the consumption on the natural source is also minimized. In this manner, the objects of increasing the benefit and achieving the concept of the sustainable development are achieved by the industry in the nowadays, when the technology and the industry are developed both highly and in high-speed.

The high-speed page wide printing method has been widely applied in the printing devices in the industry and at homes, for example, the ink-jet printers, the laser printers and the dot-matrix printers, for providing documents having high printing quality, both in high speed and in high image output standard. Wherein, the single-pass printing technology applied in the ink-jet printer is most popular, which has the advantage of ink saving. Therefore, the printers applied the single-pass printing technology is widely used in the industry and at homes. The printers execute the printing operation by means of partitioning the image data into a plurality of printing regions and in every of the plurality of printing regions, only one printing process will be executed. That is, at the image position of every of the plurality of printing regions, image is formed with the single injection of the ink.

Please refer to FIG. 1A and FIG. 1B, wherein FIG. 1A is a schematic diagram displaying the execution of the printing operation to a first printing region by the conventional printing device, through the single-pass printing technology, and FIG. 1B is a schematic diagram displaying the execution of the printing operation to a second printing region by the conventional printing device, through the single-pass printing technology. As shown in FIG. 1A and FIG. 1B, the ink-jet device 11 of the conventional printing device has a side length L. Thus, when the ink-jet device 11 executes the printing operation through the single-pass printing technology, the ink-jet device 11 executes the printing operation to a first printing region A1 of the paper 12, wherein the side length L of the first printing region A1 is substantially equal to the side length L of the ink-jet device 11. When the ink-jet device 11 moves over the first printing region A1, the ink-jet device 11 executes the ink-jet operation to the image positions of the first printing region A1. After the ink-jet operation to the image positions of the first printing region A1 being completed, the printing device moves forward the paper 12 with a distance L, as shown in FIG. 1B. The paper-moving distance L is substantially equal to the side length L of the ink-jet device 11 (or the side length L of the first printing region A1). Then, the ink-jet device 11 executes the printing operation to a second printing region A2 of the paper 12, wherein the side length L of the second printing region A2 is substantially equal to the side length L of the ink-jet device 11. When the printing device moves over the second printing region A2, the ink jet device 11 executes the ink-jet operation to the image positions of the second printing region A2. After the ink jet operation to the image positions of the second printing region A2 being completed, the ink jet device 11 moves forward the paper 12 with a distance L again, for executing the next printing operation. However, when the printing operation to the paper 12 is completed, no more ink-jet operation will be executed and the paper 12 will be moved out from the printing device. Thus, the printing device completes the execution of the printing operation to the paper 12, through the single-pass printing technology.

However, when one of the plurality of the ink-jet nozzle (not shown in the figure) of the ink-jet device 11 has a malfunction, for example, the ink-jet nozzle being blocked, the drop of the ink injected through the ink-jet nozzle beings too small, the ink being injected in wrong direction, or the distribution of the ink injected being not evenly, the resulting printing quality of the printing operation is deteriorated.

Please refer to FIG. 2A, FIG. 2B, and FIG. 2C, wherein FIG. 2A is a schematic diagram displaying the position relation between the ink-jet nozzle and the partition region, when the conventional printing device executes the printing operation to the first printing region. FIG. 2B is a schematic diagram displaying the image formation of the printing operation of the conventional printing device, when one of the ink-jet nozzles thereof is made of bad-quality material. FIG. 2C is a schematic diagram displaying the image formation of the printing operation of the conventional printing device, when one of the ink-jet nozzles thereof is blocked. As shown in FIG. 2A, the ink-jet device 11 includes ink-jet nozzles 111, 112, 113, 114, 115, 116, and when ink is injected to the paper 12 through these ink jet nozzles, ink-jet zones 121, 122, 123, 124, 125, 126 are formed on the paper 12, respectively corresponding to the ink-jet nozzles 111, 112, 113, 114, 115, 116. Besides, when the ink-jet nozzles 111, 112, 113, 114, 115, 116 respectively correspond to the first printing region A1 of the paper 12, the first printing region A1 can be divided into a first partition region A11, a second partition region A12, a third partition region A13, a fourth partition region A14, a fifth partition region A15, and a sixth partition region A16.

Wherein, when any of the ink-jet nozzles 111, 112, 113, 114, 115, 116 of the ink jet device 11 is blocked or made of bad-quality material, for example, when the quality of the ink injected through the ink-jet nozzle 112 is bad (i.e. the drop of the ink injected through the ink-jet nozzle beings too small, or the distribution of the ink injected being not evenly), the image position of the ink-jet operation may be at the wrong position of the paper or the concentration of the image formed on the paper may be too low, as shown in FIG. 2B. Therefore, a defect image forming region B is formed in the first printing region A1. Or, when the ink-jet nozzle 113 is blocked (as shown in FIG. 2A), no ink may be injected through the ink-jet nozzle 113, to the ink-jet zone 123. Thus, no image is formed at the third partition region A13, resulting in the formation of the non-image forming region C, as shown in FIG. 2C. Besides, the above-mentioned malfunction of the ink-jet nozzle is not only difficult to be repaired, but also resulting in the deterioration of the printing quality. Moreover, the malfunction of the ink-jet nozzle causes the unnecessary waste of the paper and the ink, resulting in the raising of the printing cost, the increasing of the time cost of the industry and the consumption on the natural source.

Therefore, it is desirable to provide an improved high-speed page wide printing method, and a printing device adaptive to the improved high-speed page wide printing method, for mitigating and/or obviating the afore-mentioned problems and maintaining the printing quality of the printing operation even when some of the ink-jet nozzles having a malfunction, with the lowered cost and the minimized unnecessary waste.

### SUMMARY OF THE INVENTION

The main object of the present invention is to provide a high-speed page wide printing method, and a printing device adaptive to the high-speed page wide printing method, capable of obviating the drawbacks of the conventional printing device, including: the location error of the image position, the too low concentration of the image being formed, or the non-image forming after the execution of the printing operation, when one of the ink-jet nozzles thereof having a malfunction. In addition, the mitigation of other drawbacks of the conventional printing device, such as the deterioration of the printing quality, the waste of the paper and the ink, the raising of the cost of the paper, the increasing of the time cost, and the unnecessary consumption on the natural source, is also the object of the present invention.

Another object of the present invention is to provide a high-speed page wide printing method, and a printing device adaptive to the high-speed page wide printing method, capable of executing the printing operation normally even some of the ink jet nozzles having a malfunction, by means of enlarging the aperture of the ink-jet nozzles of the ink-jet device of the printing device to enlarge the ink-jet regions corresponding thereto. Wherein, the radius of the ink jet region is equal to or larger than the distance from the center of the ink-jet region of the odd-number ink-jet nozzle, to the center of the ink-jet region of the adjacent even-number ink-jet nozzle. That is, the radius of the ink-jet region is equal to or larger than the at least 1.5 times of the radius of the plurality of the odd-number ink-jet nozzles and the plurality of the even-number ink-jet nozzles, wherein 1.5 to 2 times is the preferable range. In addition, the lowering of the cost, the removal of the unnecessary waste, the raising of the efficiency of the operation, and the minimization of the consumption on the natural source are also the objects of the present invention.

To achieve the object, a broader aspect of the present invention is to provide a high-speed page wide printing method, comprising the steps of: providing a printing device and a medium, wherein the printing device at least comprises an ink-jet device; the ink-jet device including a plurality of odd-number ink-jet nozzles and a plurality of even-number ink-jet nozzles, wherein the odd-number ink-jet nozzle and the adjacent even-number ink-jet nozzle form a set and are controlled by the same set of printing control data; the plurality of odd-number ink-jet nozzles and the plurality of even-number ink-jet nozzles having an ink-jet region corresponding to the medium, wherein the radius of the ink-jet region is equal to or larger than the distance from the center of the ink-jet region of the odd-number ink-jet nozzle, to the center of the ink-jet region of the adjacent even-number ink-jet nozzle; the printing device receiving a printing order and the ink-jet device executing an ink jet operation in response to the printing order, wherein the ink injected through every of the plurality of the odd-number ink-jet nozzles is at least partially overlapped with the ink injected through the adjacent even-number ink-jet nozzle on the medium; and the ink jet device completing the ink-jet operation, for completing a printing operation to a first printing region of the medium.

To achieve the object, another broader aspect of the present invention is to provide an ink-jet device for executing a printing operation to a medium, at least comprising an ink-jet device, including a plurality of odd-number ink-jet nozzles and a plurality of even-number ink-jet nozzles, wherein the odd-number ink-jet nozzle and the adjacent even-number ink-jet nozzle form a set and are controlled by the same set of printing control data; the plurality of odd-number ink-jet nozzles and the plurality of even-number ink-jet nozzles having an ink-jet region corresponding to the medium, wherein the radius of the ink-jet region is equal to or larger than the distance from the center of the ink-jet region of the odd-number ink-jet nozzle, to the center of the ink-jet region of the adjacent even-number ink-jet nozzle.

### BRIEF DESCRIPTION OF THE DRAWINGS

FIG. 1A is a schematic diagram displaying the execution of the printing operation to a first printing region by the conventional printing device, through the single-pass printing technology.

FIG. 1B is a schematic diagram displaying the execution of the printing operation to a second printing region by the conventional printing device, through the single-pass printing technology.

FIG. 2A is a schematic diagram displaying the position relation between the ink jet nozzle and the partition region, when the conventional printing device executes the printing operation to the first printing region.

FIG. 2B is a schematic diagram displaying the image formation of the printing operation of the conventional printing device, when one of the ink-jet nozzles thereof is made of bad-quality material.

FIG. 2C is a schematic diagram displaying the image formation of the printing operation of the conventional printing device, when one of the ink-jet nozzles thereof is blocked.

FIG. 3 is a schematic diagram displaying the elements of the printing device according to one preferred embodiment of the present invention.

FIG. 4 is a schematic diagram displaying the execution of the printing operation to the medium of the printing device, according to one preferred embodiment of the present invention.

FIG. 5A is a schematic diagram displaying the execution of the printing operation of the printing device of the present invention, when one of the ink-jet nozzles having a malfunction.

FIG. 5B is a schematic diagram displaying the image formation of the printing operation of the printing device of the present invention, when one of the ink-jet nozzles having a malfunction.

FIG. 6 is a schematic diagram displaying the flowchart of the printing method, according to one preferred embodiment of the present invention.

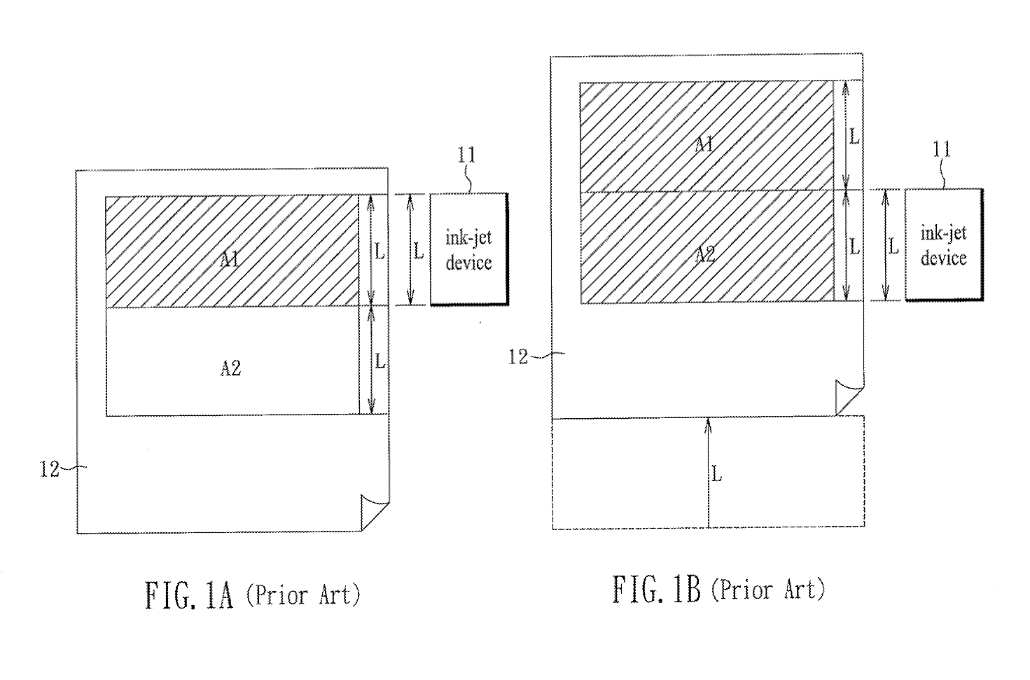

### DETAILED DESCRIPTION OF THE PREFERRED EMBODIMENT

Other objects, advantages, and novel features of the invention will become more apparent from the following detailed description when taken in conjunction with the accompanying drawings. The description and the drawing in the specification of the present invention are essentially used for explanation only; they are not supposed to be used for limiting the scope of the present invention.

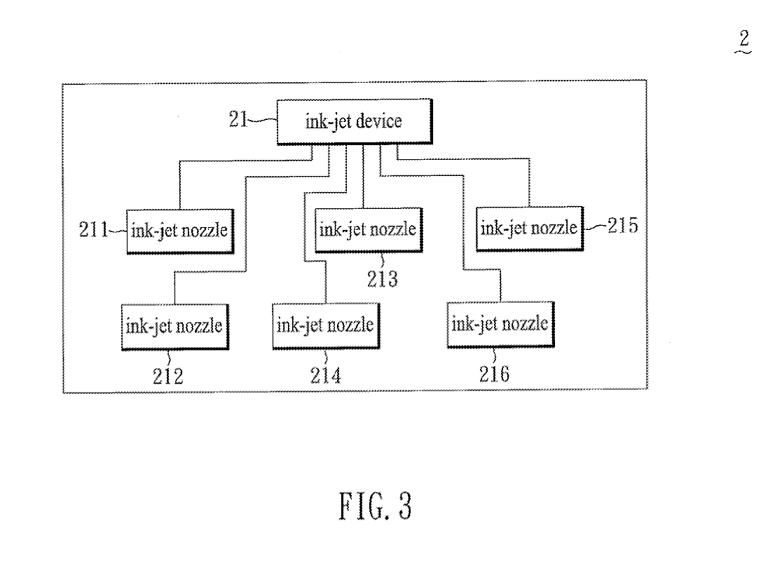

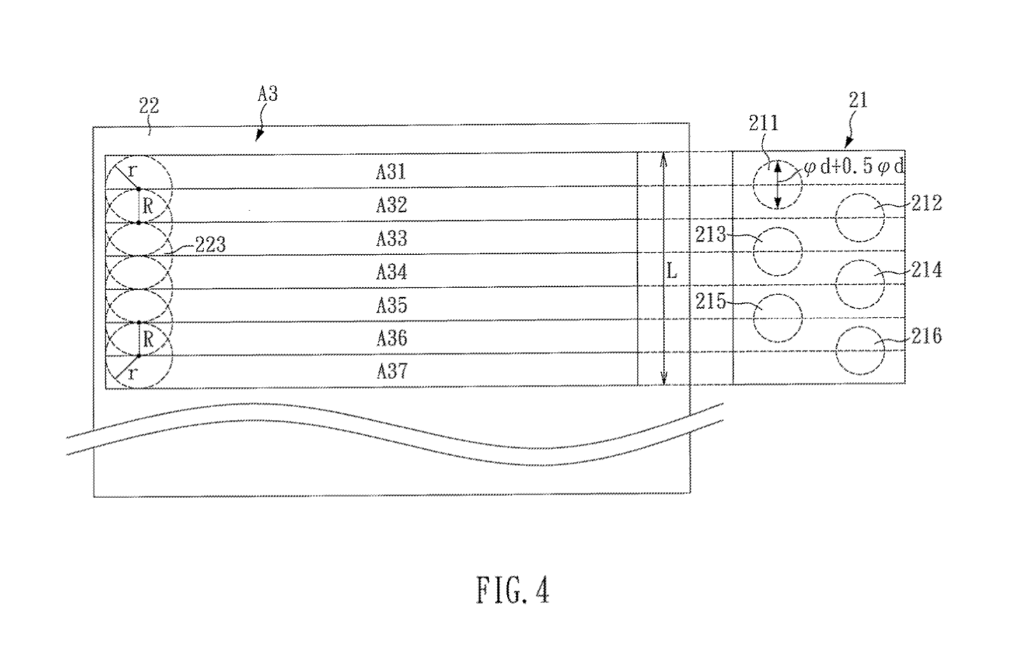

Please refer to FIG. 3 and FIG. 4, wherein FIG. 3 is a schematic diagram displaying the elements of the printing device according to one preferred embodiment of the present invention, and FIG. 4 is a schematic diagram displaying the execution of the printing operation to the medium of the printing device, according to one preferred embodiment of the present invention. As shown in FIG. 3 and FIG. 4, the printing device 2 of the present invention at least comprises an ink-jet device 21, wherein the ink-jet device 21 has a side length L and includes a plurality of odd-number ink-jet nozzles 211, 213, 215 and a plurality of even-number ink-jet nozzles 212, 214, 216. The plurality of odd-number ink-jet nozzles 211, 213, 215 and the plurality of even-number ink-jet nozzles 212, 214, 216 are arranged interleavingly. Besides, the plurality of odd-number ink-jet nozzles 211, 213, 215 and the plurality of even-number ink-jet nozzles 212, 214, 216 are arranged on two different rows respectively. In addition, on each of these two rows, every of the plurality of odd-number ink-jet nozzles 211, 213, 215 and every of the plurality of even-number ink-jet nozzles 212, 214, 216 are preferably arranged in sequence, as shown in FIG. 4. However, the arrangement of the plurality of odd-number ink-jet nozzles 211, 213, 215 and the plurality of even-number ink-jet nozzles 212, 214, 216 are not thus limited. In the present invention, the printing device 2 is used to execute a printing operation to a medium 22, and the printing device 2 can be, but not limited to, an ink-jet printer, a photo ink-jet printer, or a multifunction printer. The medium 22 can be, but not limited to, an ordinary printing paper, a photo printing paper, an airlaid paper, a letter paper or an envelope. Besides, there is a first printing region A3 on the medium 22. In addition, the side length L of the ink-jet device 21 is substantially equal to the side length L of the first printing region A3. Therefore, when the ink-jet device 21 executes the printing operation to the medium, through the single-pass printing technology, the printing operation is achieved through the following process: the ink-jet device 21 injects the ink to the medium 22 from left to right, at a constant speed, until the ink-jet operation to the image positions of the first printing region A3 of the medium 22 being completed.

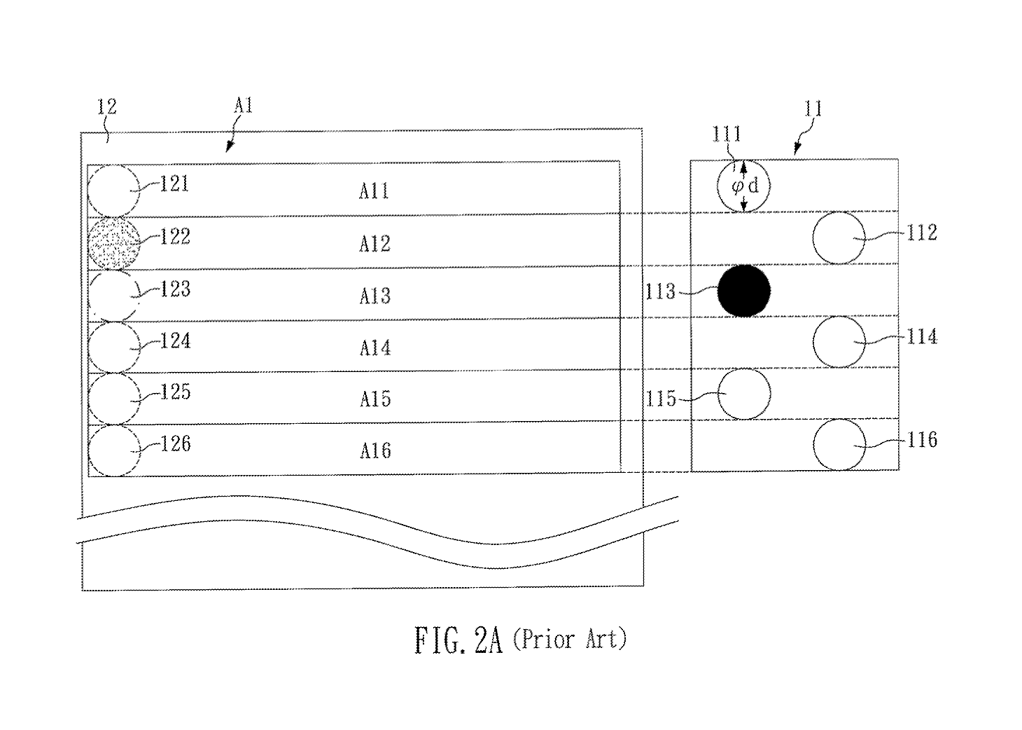

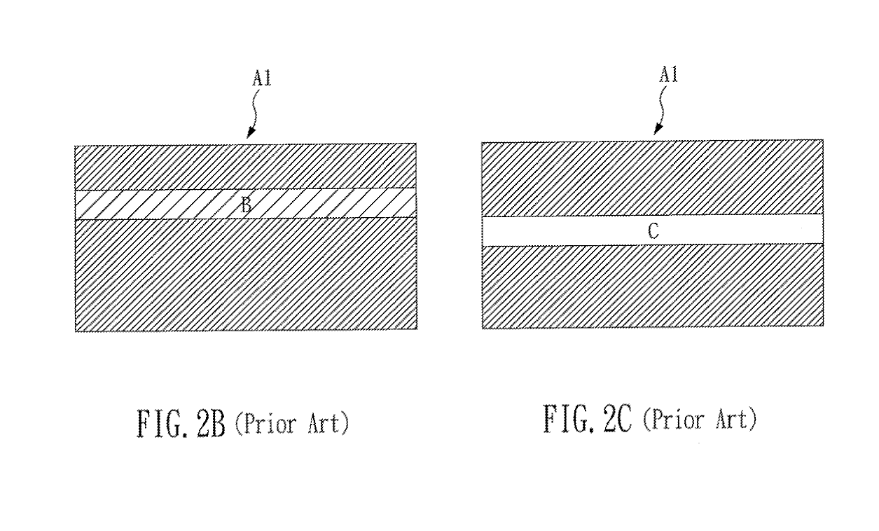

According to the present invention, the ink-jet device 21 may include two or more ink-jet nozzles, installed on the ink-jet device 21. In the present embodiment, the ink-jet device 21 includes 3 odd-number ink-jet nozzles 211, 213, 215 and 3 even-number ink-jet nozzles 212, 214, 216. Wherein, the aperture of every of the odd-number ink-jet nozzles 211, 213, 215 and the 3 even-number ink-jet nozzles 212, 214, 216 is larger than the aperture of the conventional ink-jet nozzles. For example, when the aperture of the conventional ink-jet nozzle is φd, as shown in FIG. 2A, the aperture of the odd-number ink-jet nozzles 211, 213, 215 and the even-number ink-jet nozzles 212, 214, 216 is preferably φd+0.5φd, which is 0.5φd larger than the aperture of the conventional ink-jet nozzles. That is, the aperture of the odd-number ink-jet nozzles 211, 213, 215 and the even-number ink-jet nozzles 212, 214, 216 is 1.5 times of the aperture of the conventional ink-jet nozzles, wherein 1.5 to 2 times is the preferable range.

With the larger-sized aperture, when the printing device 2 executes the printing operation, the ink injected through every of the odd-number ink-jet nozzles 211, 213, 215 is at least partially overlapped with the ink injected through the adjacent even-number ink-jet nozzles 212, 214, 216 on the medium 22. In addition, in the ink-jet device 21 of the present invention, the ink jet region 221, 223, 225 of every of the odd-number ink-jet nozzles 211, 213, 215, and the ink-jet region 222, 224, 226 of every of the even-number ink-jet nozzles 212, 214, 216 are determined by the radius of the odd-number ink jet nozzles 211, 213, 215 and the even-number ink-jet nozzles 212, 214, 216. In some embodiments of the present invention, the radius r of the ink-jet region 221, 223, 225 of every of the odd-number ink-jet nozzles 211, 213, 215, and the ink-jet region 222, 224, 226 of every of the even-number ink-jet nozzles 212, 214, 216 is substantially equal to or larger than the distance R from the center of the ink-jet regions 221, 222, 223, 224, 225, 226, to the center of the adjacent ink-jet regions 222, 223, 224, 225. However, the best mode is that the radius r of the ink-jet region 221, 222, 223, 224, 225, 226 is equal to the distance R from the center of the ink-jet regions 221, 222, 223, 224, 225, 226, to the center of the adjacent ink-jet regions 222, 223, 224, 225. In other words, the ink jet regions of the odd-number ink-jet nozzle and the adjacent even-number ink-jet nozzle, for example, the ink-jet region of the odd-number ink jet nozzle 211 and the ink-jet region of the even-number ink-jet nozzle 212, the ink-jet region of the even-number ink-jet nozzle 212 and the ink-jet region of the odd-number ink-jet nozzle 213, the ink-jet region of the odd-number ink-jet nozzle 213 and the ink-jet region of the even-number ink jet nozzle 214, the ink-jet region of the even-number ink-jet nozzle 214 and the ink-jet region of the odd-number ink-jet nozzle 215, the ink jet region of the odd-number ink-jet nozzle 215 and the ink-jet region of the even-number ink-jet nozzle 216, are at least partially overlapped with each other.

Please refer to FIG. 4 again, in the present embodiment, the odd-number ink-jet nozzles 211, 213, 215 of the ink-jet device 21 respectively correspond to the ink-jet regions 221, 223, 225 on the medium 22. Besides, the even-number ink-jet nozzles 212, 214, 216 of the ink-jet device 21 respectively correspond to the ink-jet regions 222, 224, 226 on the medium 22. The odd-number ink-jet nozzle 211 is used to execute the ink-jet operation to a first partition region A31 and a second partition region A32 of the first printing region A3. The even-number ink-jet nozzle 212 is used to execute the ink-jet operation to the second partition region A32 and a third partition region A33 of the first printing region A3. The odd-number ink-jet nozzle 213 is used to execute the ink-jet operation to the third partition region A33 and a fourth partition region A34 of the first printing region A3. The even-number ink-jet nozzle 214 is used to execute the ink-jet operation to the fourth partition region A34 and a fifth partition region A35 of the first printing region A3. The odd-number ink-jet nozzle 215 is used to execute the ink-jet operation to the fifth partition region A35 and a sixth partition region A36 of the first printing region A3. The even-number ink-jet nozzle 216 is used to execute the ink-jet operation to the sixth partition region A36 and a seventh partition region A37 of the first printing region A3.

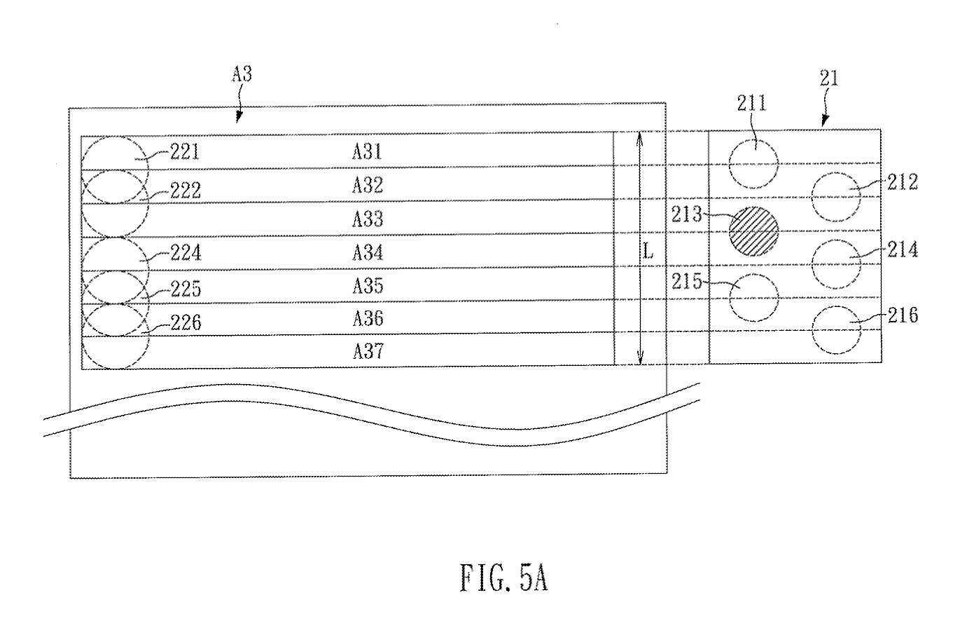

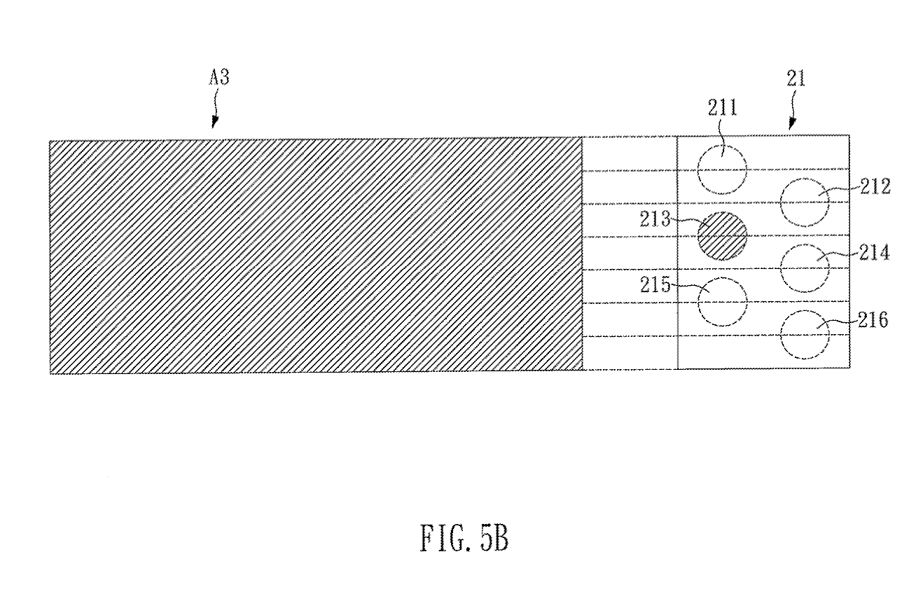

Please refer to FIG. 5A and FIG. 5B, wherein FIG. 5A is a schematic diagram displaying the execution of the printing operation of the printing device of the present invention, when one of the ink-jet nozzles having a malfunction, and FIG. 5B is a schematic diagram displaying the image formation of the printing operation of the printing device of the present invention, when one of the ink-jet nozzles having a malfunction. In some embodiments, when the ink jet device 21 executes the printing operation to the first printing region A3, the odd-number ink-jet nozzle 211 is used to execute the ink-jet operation to the first partition region A31 and the second partition region A32 of the first printing region A3. The even-number ink-jet nozzle 212 is used to execute the ink-jet operation to the second partition region A32 and the third partition region A33 of the first printing region A3. The odd-number ink-jet nozzle 213 is used to execute the ink-jet operation to the third partition region A33 and the fourth partition region A34 of the first printing region A3. The even-number ink-jet nozzle 214 is used to execute the ink jet operation to the fourth partition region A34 and the fifth partition region A35 of the first printing region A3. The odd-number ink-jet nozzle 215 is used to execute the ink-jet operation to the fifth partition region A35 and the sixth partition region A36 of the first printing region A3. The even-number ink-jet nozzle 216 is used to execute the ink-jet operation to the sixth partition region A36 and the seventh partition region A37 of the first printing region A3.

Wherein, the odd-number ink-jet nozzle 211 and the adjacent even-number ink-jet nozzle 212 form one set, the odd-number ink-jet nozzle 213 and the adjacent even-number ink-jet nozzle 214 form another set, and the odd-number ink-jet nozzle 215 and the adjacent even-number ink-jet nozzle 216 form the other set. In these sets, same ink-jet data is transmitted to the two ink jet nozzles of the set, i.e. the odd-number ink-jet nozzle and the adjacent even-number ink-jet nozzle of the set. Thus, the odd-number ink-jet nozzle and the adjacent even-number ink-jet nozzle of the set are both used to ink-jet the same data. As a result, in every of the above-mentioned sets, the ink injected through the odd-number ink-jet nozzle is at least partially overlapped with the ink injected through the adjacent even-number ink-jet nozzle of the same set on the medium 22, as the second partition region A32 to the sixth partition region A36 shown in FIG. 4. However, the arrangement of the above-mentioned sets of the ink-jet nozzles and the composition of the above-mentioned sets are not thus limited. In the present embodiment, when the odd-number ink-jet nozzle 213 has a malfunction, for example, when the ink-jet nozzle 213 is blocked or made of bad-quality material, the odd-number ink jet nozzle 213 cannot be used to execute the ink-jet operation to the ink-jet regions 223, as shown in FIG. 4. As a result, the odd-number ink-jet nozzle 213 cannot be used to execute the ink-jet operation to the third partition region A33 and the fourth partition region A34. However, since the even-number ink-jet nozzle 214 of the same set ink-jets the same data as the data previously to be ink-jetted by the odd-number ink-jet nozzle 213, and the ink jet region 224 is enlarged to cover the fourth partition region A34 and the lower portion of the third partition region A33 due to the enlargement of the aperture of the even-number ink-jet nozzle 214, which makes the aperture of the even-number ink-jet nozzle 214 to be enlarged as 1.5 times of the aperture of the convention ink-jet nozzle. Besides, the ink-jet region 222 is enlarged to cover the second partition region A32 and the upper portion of the third partition region A33 due to the enlargement of the aperture of the even-number ink-jet nozzle 212, which makes the aperture of the even-number ink-jet nozzle 212 to be enlarged as 1.5 times of the aperture of the convention ink-jet nozzle. Therefore, the ink-jet operation to the third partition region A33 and the fourth partition region A34 previously to be executed by the odd-number ink jet nozzle 213 having the malfunction, can now be achieved by these adjacent even-number ink-jet nozzles 212, 214. In this manner, the resulting printing quality of the printing operation, through the execution of the above-mentioned ink-jet operation, is not deteriorated, as shown in FIG. 5B.

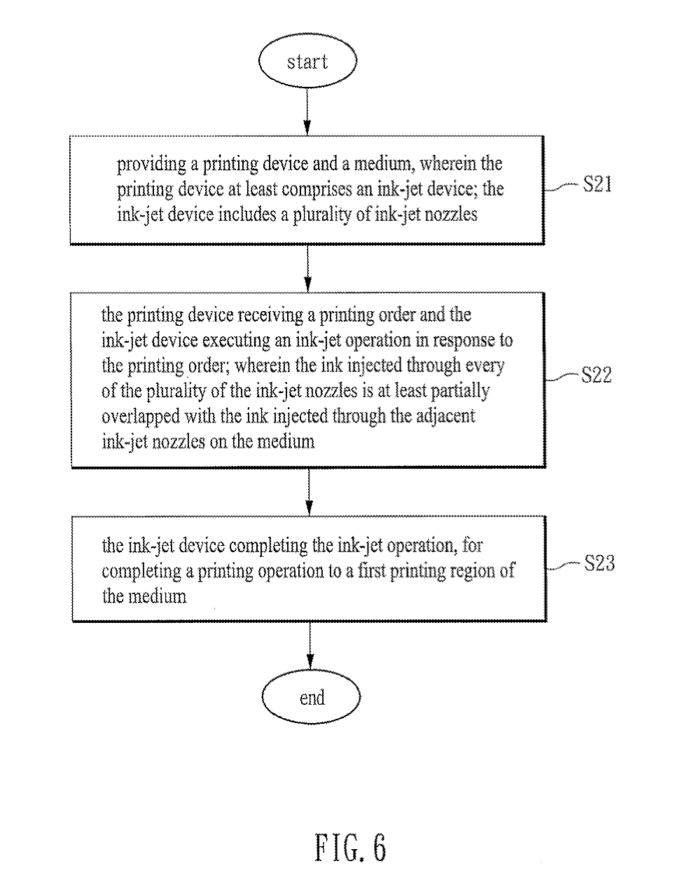

Please refer to FIG. 6, which is a schematic diagram displaying the flowchart of the printing method, according to one preferred embodiment of the present invention. As shown in FIG. 6, the printing method of the present invention at least comprises the following steps: First, as described in step S21, providing a printing device 2 and a medium 22, wherein the printing device 2 at least comprises an ink-jet device 21. The ink-jet device 21 can be adaptive to an ink-jet printer, a photo ink-jet printer, or a multifunction printer. The ink-jet device 21 includes a plurality of odd-number ink-jet nozzles and a plurality of even-number ink-jet nozzles, wherein the plurality of odd-number ink-jet nozzles and the plurality of even-number ink-jet nozzles are arranged interleavingly. The medium 22 can be, but not limited to, an ordinary printing paper, a photo printing paper, an airlaid paper, a letter paper or an envelope. Then, as described in step S22, the printing device 2 receives a printing order, for printing and image-forming the characters, the data or the image to be printed on the medium 22. The ink-jet device 21 executes an ink-jet operation in response to the printing order, which is executed under the control of the ink-jet device 21 through the following process: the ink-jet device 21 injecting the ink to the medium 22 from left to right, at a constant speed, for executing the ink-jet operation to the image positions of the medium 22. According to the present invention, every of the plurality of the odd-number ink-jet nozzles and every of the plurality of the even-number ink-jet nozzles have a larger-sized aperture than the conventional ink-jet nozzles. The odd-number ink-jet nozzle and the adjacent even-number ink-jet nozzle form a set, wherein same ink-jet data is transmitted to the two ink-jet nozzles of the set. That is, the odd-number ink-jet nozzle and the adjacent even-number ink-jet nozzle of the set are both used to ink jet the same data. The ink-jet region of every of the plurality of odd-number ink-jet nozzles and the ink-jet region of every of the plurality of even-number ink-jet nozzles are determined by the radius (or the diameter) of the odd-number ink-jet nozzles and the even-number ink-jet nozzles. In some embodiments, the radius r of the ink-jet region of every of the plurality of odd-number ink-jet nozzles and the ink-jet region of every of the plurality of even-number ink-jet nozzles is substantially equal to or larger than the distance R from the center of the ink-jet regions of the odd-number ink-jet nozzle, to the center of the ink-jet regions of the adjacent even-number ink-jet nozzle. That is, the radius of the ink-jet region is equal to or larger than the at least 1.5 times of the radius of the plurality of the odd-number ink jet nozzles and the plurality of the even-number ink-jet nozzles, wherein 1.5 to 2 times is the preferable range. In other words, the ink-jet regions of the odd-number ink-jet nozzle and the adjacent even-number ink-jet nozzle are at least partially overlapped with each other, enabling the ink injected through every of the plurality of odd-number ink-jet nozzles is at least partially overlapped with the ink injected through the adjacent even-number ink-jet nozzle on the medium 22. At final, as described in step S23, the ink-jet device 21 completes the ink-jet operation, for completing the printing operation to the first printing region A3 of the medium 22. In this manner, the printing device of the present invention can execute the printing operation normally, even some of the ink-jet nozzles of the ink-jet device thereof having a malfunction. Therefore, the cost can be lowered and the unnecessary waste can be removed. Besides, the efficiency of the operation can be raised and the consumption on the natural source can be minimized.

As described above, in the printing method and the printing device adaptive to the printing method of the present invention, the ink-jet regions of the plurality of ink-jet nozzles of the ink-jet device of the printing device is enlarged, by means of increasing the diameter of the plurality of ink-jet nozzles. Thus, the ink jet region of one of the plurality of the ink-jet nozzles is at least partially overlapped with the ink-jet region of the adjacent ink jet nozzle, enabling the printing method and the printing device adaptive to the printing method of the present invention to execute the printing operation normally, even some of the ink-jet nozzles of the ink-jet device thereof having a malfunction. Therefore, the cost can be lowered and the unnecessary waste can be removed. Besides, the efficiency of the operation can be raised and the consumption on the natural source can be minimized. As a result, the printing method and the printing device adaptive to the printing method of the present invention meet the requirement of the industrial applicability.

Although the present invention has been explained in relation to its preferred embodiment, it is to be understood that many other possible modifications and variations can be made without departing from the spirit and scope of the invention as hereinafter claimed.

What is claimed is:

1. A high-speed page wide printing method, comprising the steps of:
providing a printing device and a medium, wherein the printing device at least comprises an ink-jet device; the ink-jet device including a plurality of odd-number ink-jet nozzles and a plurality of even-number ink-jet nozzles, wherein the odd-number ink-jet nozzle and the adjacent even-number ink-jet nozzle form a set and are controlled by the same set of printing control data; the plurality of odd-number ink-jet nozzles and the plurality of even-number ink-jet nozzles having an ink-jet region corresponding to the medium, wherein the radius of the ink-jet region is equal to or larger than the distance from the center of the ink-jet region of the odd-number ink jet nozzle, to the center of the ink-jet region of the adjacent even-number ink jet nozzle;
the printing device receiving a printing order and the ink-jet device executing an ink-jet operation in response to the printing order, wherein the ink injected through every of the plurality of the odd-number ink-jet nozzles is at least partially overlapped with the ink injected through the adjacent even-number ink-jet nozzle on the medium; and
the ink-jet device completing the ink-jet operation, for completing a printing operation to a first printing region of the medium.

2. The high-speed page wide printing method as claimed in claim 1, wherein the radius of the ink-jet region is equal to or larger than the at least 1.5 times of the radius of the plurality of the odd-number ink-jet nozzles and the plurality of the even-number ink-jet nozzles.

3. The high-speed page wide printing method as claimed in claim 1, wherein the 1.5 to 2 times of the radius of the plurality of the odd-number ink-jet nozzles and the plurality of the even-number ink-jet nozzles is the preferable range of the radius of the ink-jet region.

4. A printing device, for executing a printing operation to a medium, at least comprising:
an ink-jet device, including a plurality of odd-number ink-jet nozzles and a plurality of even-number ink-jet nozzles, wherein the odd-number ink-jet nozzle and the adjacent even-number ink jet nozzle form a set and are controlled by the same set of printing control data; the plurality of odd-number ink-jet nozzles and the plurality of even-number ink-jet nozzles having an ink-jet region corresponding to the medium, wherein the radius of the ink-jet region is equal to or larger than the distance from the center of the ink-jet region of the odd-number ink-jet nozzle, to the center of the ink-jet region of the adjacent even-number ink jet nozzle.

5. The printing device as claimed in claim 4, wherein the radius of the ink-jet region is equal to or larger than the at least 1.5 times of the radius of the plurality of the odd-number ink-jet nozzles and the plurality of the even-number ink-jet nozzles.

6. The printing device as claimed in claim 4, wherein the 1.5 to 2 times of the radius of the plurality of the odd-number ink-jet nozzles and the plurality of the even-number ink-jet nozzles is the preferable range of the radius of the ink-jet region.
